(19) United States
(12) Patent Application Publication
(10) Pub. No.: US 2011/0148803 A1
(43) Pub. Date: Jun. 23, 2011

(54) Remote Controller Having A Touch Panel For Inputting Commands

(75) Inventor: Lin Xu, Shanghai (CN)

(73) Assignee: AMLOGIC CO., LTD., Santa Clara, CA (US)

(21) Appl. No.: 12/646,952

(22) Filed: Dec. 23, 2009

(51) Int. Cl. G06F 3/045; G06F 3/038

(52) U.S. Cl. 345/174; 345/212

(57) ABSTRACT

A remote control device comprises: a unit having a top surface; and a touch panel disposed on the top surface, wherein the touch panel covers all of the top surface. The touch panel comprises touch sensing channels positioned on the touch panel for detecting an object touching or in proximity to the touch panel.

### FIELD OF INVENTION

This invention relates to a remote controller, and, in particular, to a remote controller that has a capacitive touch panel for inputting commands.

### BACKGROUND

The manner for controlling an electronic device, e.g. an air conditioning unit, a television, a DVD player, a digital video recorder, or another electronic device, is mainly performed by a respective remote controller for the electronic device.

FIG. 1 illustrates a user operating a remote controller for a television. A user 10 directs a remote controller 12 towards a television 14. The user 10 can press one of the push buttons on the remote controller 12 with a finger to activate a push switch. This electrical activation causes the remote controller 12 to transmit a command signal from an infrared transmitter of the remote controller 12 to the television 14, e.g., to turn the television on or to increase the volume of the sound from the television.

FIG. 2a illustrates a top view of a prior art design for remote controllers. Typically, a remote controller 20 will have a plurality of push buttons, for example, push buttons 22, 24, 26, and 28. The push buttons can be pressed to activate a push switch for generating a command signal. The push bottoms and the push switches can be easily damaged due to normal usage since constant physical pushing of the push buttons can wear down the respective push switch or push button. Therefore, it is desirable to design a remote controller that can function without the use of physical push buttons or push switches.

FIG. 2b illustrates a side view of a prior art design for remote controllers. In the side view, the push buttons 22, 24, 26, and 28 protrude from the base of the remote controller 20. Notice that the remote controller 20 is rather bulky and does not offer a sleek and robust design. Additionally, the buttons 22, 24, 26, and 28 may be damaged or caught on an edge with the base when pressed. Overall, the aesthetic design and feel of the remote controller 20 is less than desirable.

As the kind and quantity of electrical devices increase, the quantity of remote controllers will also increase accordingly. As the number of remote controllers increase, the inconvenience to the user is greatly increased during the operation of the various remote controllers.

Furthermore, since many products have dedicated remote controllers, various kinds of remote controllers are available that have different specifications and functions. Even electric devices having the same use may be made with diverse specifications. Moreover, since many electronic devices are currently used in a home, such as a television, an air conditioning unit, a DVD player, etc. each provided with a dedicated remote controller, this situation may confuse and inconvenience the user. For instance, the user may inadvertently use a wrong remote controller to operate an electronic device or may lose one of the remote controllers.

A universal remote can be programmed to operate a range of electronic devices, thereby reducing the sheer number of remote controllers and complexity. However, due to the wide range of electronic devices the universal remote generally has a large set of physical buttons on the remote to accommodate the different functionality and different electronic devices. Having such a large set of physical buttons presents the problem and added complexity of ascertaining which button operates which electronic device. Thus, users may find it difficult to use a universal remote with such complexity. Therefore, it is desirable to provide a remote controller than can alter the button configuration of the remote controller to match the electronic device to be operated. Also, it is desirable for the remote controller to have designated areas on the remote controller to operate specific electronic devices.

### SUMMARY OF INVENTION

An object of this invention is to provide a remote controller that has a capacitive touch panel for replicating buttons.

Another object of this invention is to provide a remote controller that is sleek, robust, and relatively inexpensive to produce.

Yet another object of this invention is to provide a remote controller that can operate multiple electronic devices simultaneously, and adjust the button configuration on a touch panel of the universal remote accordingly.

Briefly, a remote control device is disclosed, comprising: a unit having a top surface; and a touch panel disposed on the top surface, wherein the touch panel covers all of the top surface. The touch panel can comprise touch sensing channels positioned on the touch panel for detecting an object touching or in proximity to the touch panel.

An advantage of this invention is that a remote controller is provided that has a capacitive touch panel for replicating buttons.

Another advantage of this invention is that a remote controller is provided that is sleek, robust, and relatively inexpensive to produce.

Yet another advantage is that a remote controller is provided that can operate multiple electronic devices simultaneously, and can adjust the button configuration on a touch panel of the universal remote accordingly.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a user operating a remote controller for a television.

FIG. 2a illustrates a top view of a prior art design for remote controllers.

FIG. 2b illustrates a side view of a prior art design for remote controllers.

FIG. 3a illustrates a top surface of a remote controller of the present invention having a capacitive touch panel for inputting user commands.

FIG. 3b illustrates a typical X-channel layout of the present invention.

FIG. 3c illustrates a typical Y-channel layout of the present invention.

FIGS. 4a-4b illustrate a top view and a side view of a remote controller of the present invention, which has a touch panel for inputting commands.

FIG. 5 illustrates an example of a navigation button configuration for a remote controller.

FIG. 6 illustrates an example of a standard twelve button configuration combined with the navigation button configuration.

FIG. 7 illustrates a remote controller of the present invention having four areas on the touch panel, where each area corresponds to a different electronic device to be remotely controlled.

FIG. 8 illustrates a block diagram for implementing the capacitance touch panel pattern laid on a PCB.

FIG. 9 illustrates a typical IR transmitter block.

FIG. 10 illustrates a basic theory of capacitance measurements for GPIO pins.

FIGS. 11-14 illustrate the basic states for capacitance measurements using GPIO pins.

FIG. 15 illustrates the associated waveform for states S0 and S1 of a GPIO pin for a capacitance touch sensing channel.

FIG. 16 illustrates the associated waveform for states S2 and S3 of a GPIO pin for a capacitance touch sensing channel.

FIG. 17 illustrates the waveform for states S0, S1, S2, and S3 for a capacitance touch sensing channel.

FIG. 18 illustrates a graphical user interface that can be remotely controlled by a remote controller of the present invention.

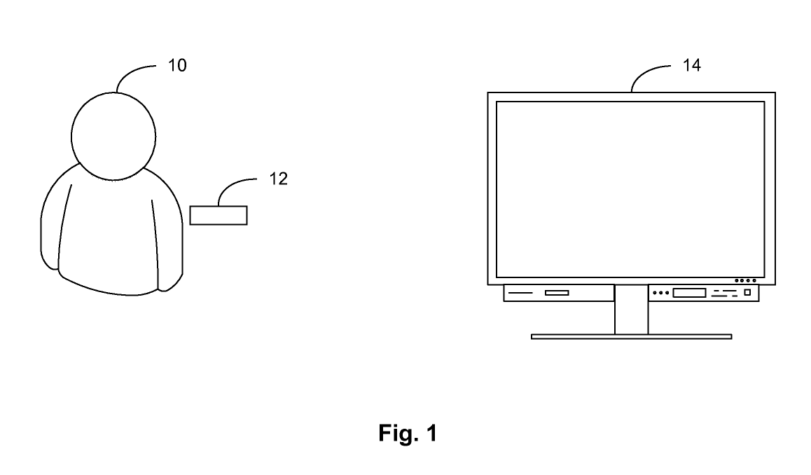

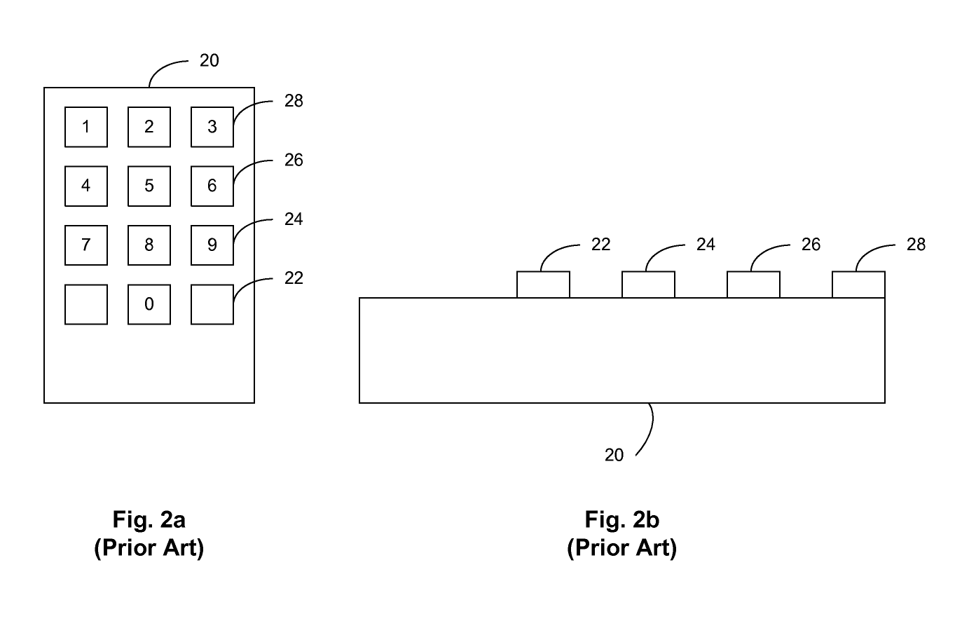

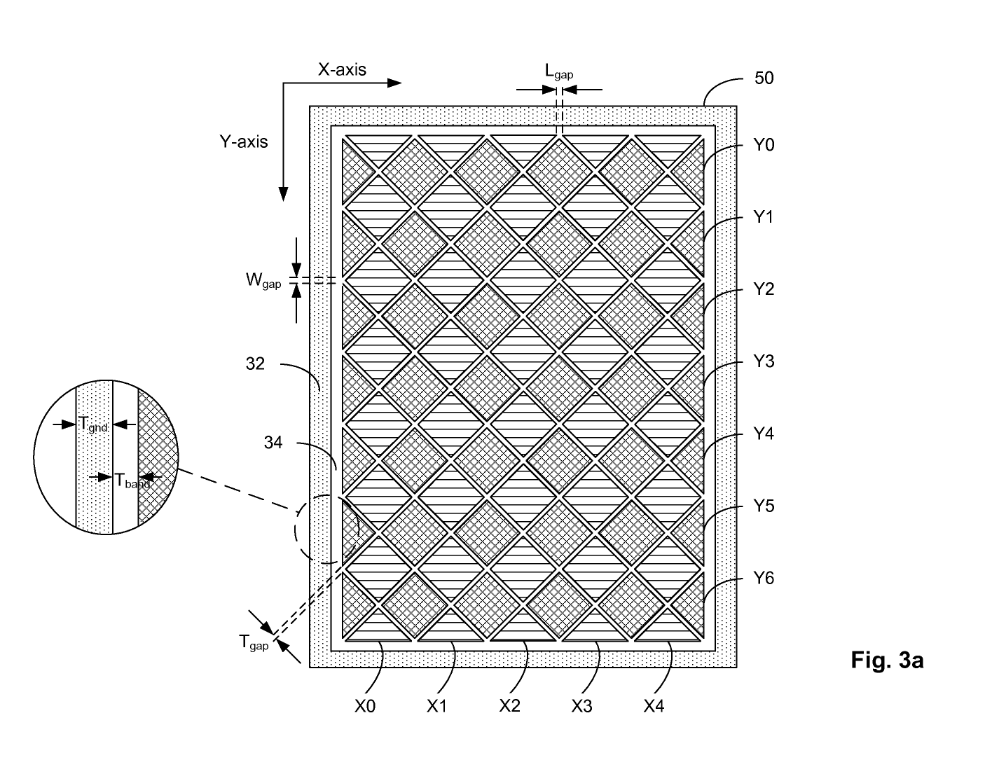

### DETAILED DESCRIPTION OF THE PREFERRED EMBODIMENTS

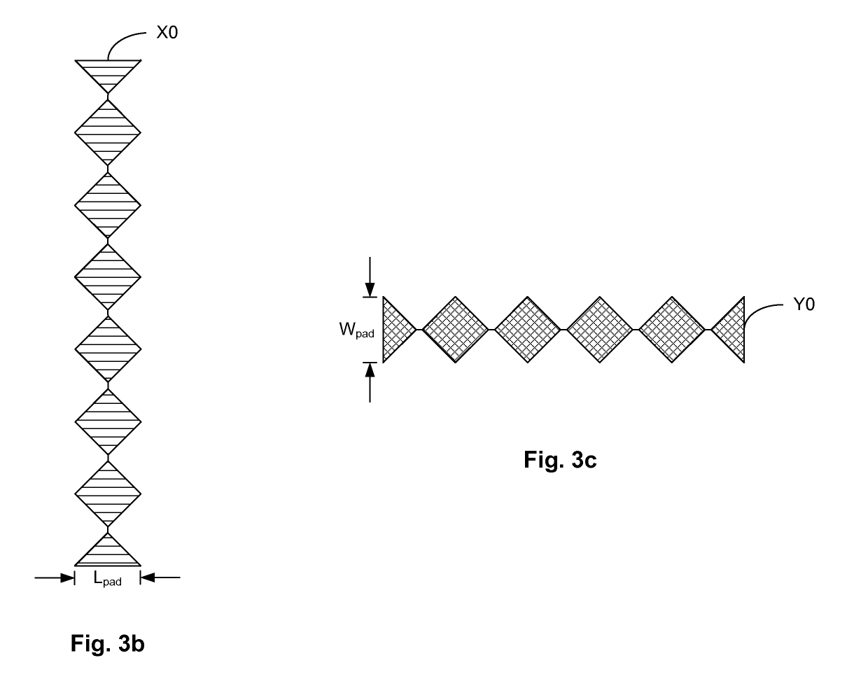

FIG. 3a illustrates a top surface of a remote controller of the present invention having a capacitive touch panel for inputting commands. A remote controller comprises a top surface 50 and a touch panel disposed on the top surface 50. The touch panel can cover some or all of said top surface. The touch panel can have five channels X0, X1, X2, X3, and X4 (positioned perpendicular to an x-axis and can be generally referred to as the X-channels) and seven channels Y0, Y1, Y2, Y3, Y4, Y5, and Y6 (positioned perpendicular to a y-axis and can be generally referred to as the Y-channels). The X-channels are perpendicular to the Y-channels forming a grid across a rectangular touch panel for detecting an object touching or in proximity to the touch panel. Each channel is connected to a capacitance touch sensor (not shown) for determining the amount of capacitance along the channel. These channels can be referred to as capacitance touch sensing channels. A channel can comprise multiple diamond shaped touch pads and triangle shaped touch pads connected together.

The channels X0-X4 are positioned along parallel rows to each other for determining the x-axis location of an object that is touching or in proximity to the touch panel. FIG. 3b illustrates a typical X-channel layout of the present invention. The channel X0 can have six diamond-shaped touch pads and two half diamond-shaped touch pads connected together to form the channel X0. Likewise, the other X-channels can be formed in a similar pattern. It is important to note that the number of touch pads per channel and the number of X-channels can vary depending on the sensitivity of the remote controller and the physical size of the touch panel.

The channels Y0-Y6 are positioned along parallel rows to each other for determining the y-axis location of an object that is touching or in proximity to the touch panel. FIG. 3c illustrates a typical Y-channel layout of the present invention. The Y-channel Y0 can have four diamond-shaped touch pads and two half diamond-shaped touch pads connected together to form the channel. Likewise, the other Y-channels can be formed in a similar pattern. It is important to note that the number of touch pads per channel and the number of Y-channels can vary depending on the sensitivity of the remote controller and the physical size of touch panel.

The diamond-shaped touch pads of the channels can be of the same size, preferably, the width of the touch pad (“Wpad”) is 8 mm and the length of the touch pad (“Lpad”) is 8 mm. The half diamond-shaped touch pads are ½ the size and shape of a diamond-shaped pad, thus resembling a triangle shape.

Referring back to FIG. 3a, preferably, there is a gap between touch pads of adjacent X-channels (“Lgap”) of about 0.7 mm and a gap between touch pads of adjacent Y-channels (“Wgap”) of about 0.7 mm.

Furthermore, the interspacing between any two touch pads within the grid of channels (“Tgap”) is about 0.5 mm. In order to form a single channel, the touch pads of the single channel can be laid on a top side of a PCB with at least the Tgap distance separating the touch pads. Since the touch pads of the single channel need to be connected to form the channel, the touch pads can be connected via connections on a bottom side of the PCB or in intermediate layers of the PCB.

The grid of X-channels and Y-channels is surrounded by a gap 34 having a thickness (“Tband”), where Tband is preferably of about 1 mm. A grounding wire 32 further surrounds the boundary of the gap 34. The thickness of the grounding wire 32 (“Tgnd”) is preferably no less than 1 mm.

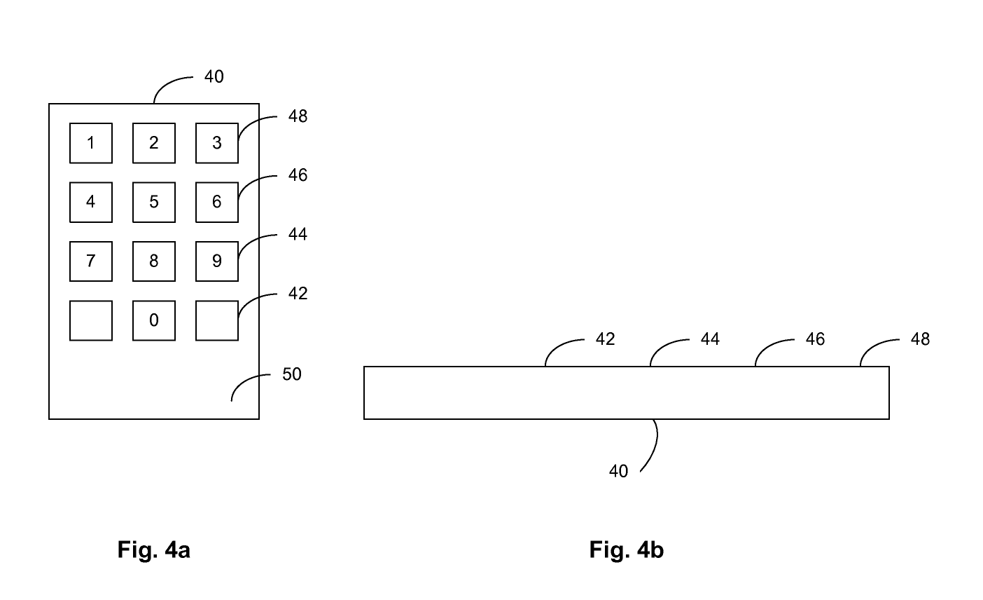

FIGS. 4a-4b illustrate a top view and a side view of a remote controller of the present invention, which has a touch panel for inputting commands. A remote control 40 can have a cover (e.g. a plastic cover, paper cover, etc.) over the touch panel to identify where the virtual buttons (e.g., virtual buttons 42, 44, 46, and 48) are located on the touch panel. Unlike prior art remote controllers, the virtual buttons are not push buttons and do not protrude from the shell of the remote controller 40. In fact, the remote controller 40 may not have any physical buttons on the top surface 50 of the remote controller 40. Instead, by simply placing an object near or touching one of the virtual buttons of the touch panel, the associated command for that button can be activated and relayed to an associated electronic device for the remote controller 40.

Since the buttons 42, 44, 46, and 48 do not have physical switches or buttons disposed on the touch panel, the buttons 42, 44, 46, and 48 can be designated in relation to any number of areas on the remote controller 40 at the user's preference. The remote controller 40 can be configured by the user using a computer interface to set the button configurations. The button configuration can be indicated on the remote controller 40. Various methods can be used to display the location of the buttons on the touch panel. For instance, a cover can be placed directly over the touch panel with button locations identified on the cover. Furthermore, other display methods can be used, for instance, LEDs positioned over the touch panel can be used to identify the button locations or a LCD screen disposed on the touch panel can display images in the designated areas to indicate the button location.

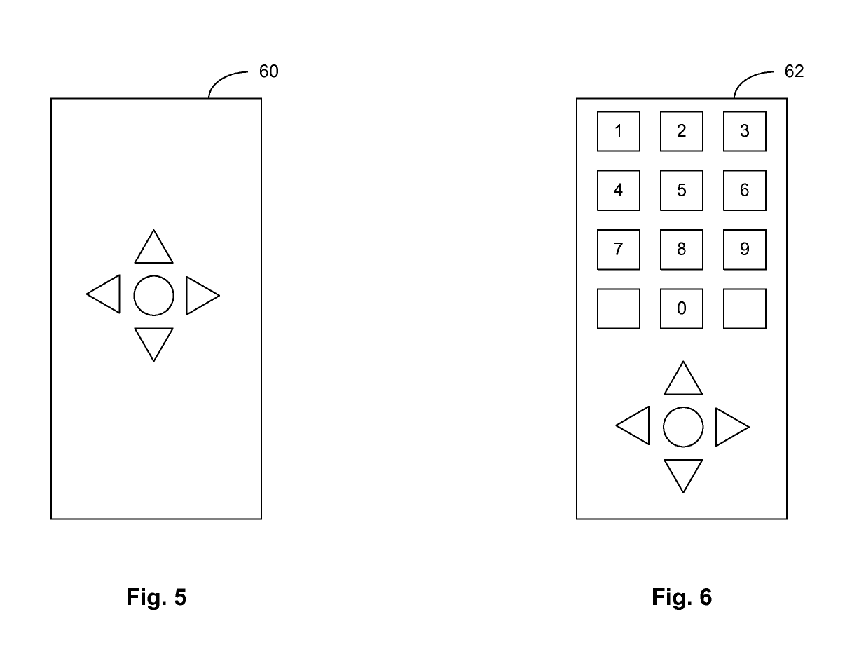

FIG. 5 illustrates an example of a navigation button configuration that can be selected by a user of the remote controller. A remote controller 60 can have directional buttons (e.g., up, down, left, right, and center) for navigating a menu on a corresponding electronic device for the remote controller 60.

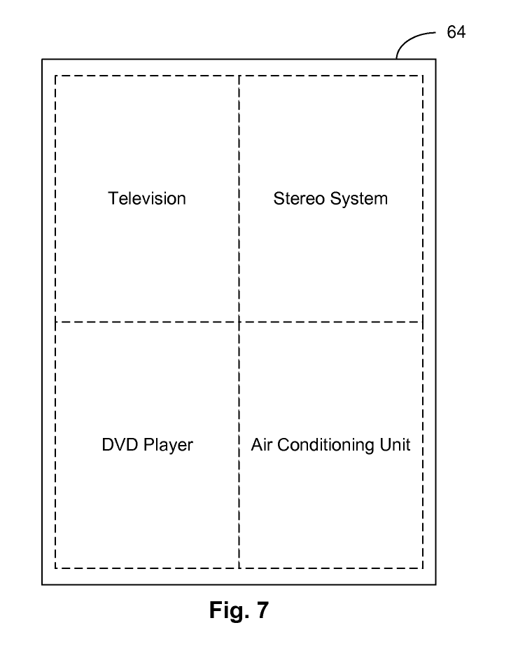

Furthermore, FIG. 6 illustrates an example of a standard twelve button configuration combined with the navigation button configuration. A remote controller 62 can have twelve buttons for inputting a digit or other command. Furthermore, a navigation button configuration can be positioned under the twelve buttons to add directional functionality to the remote controller 62.

As evidenced above, a remote controller of the present invention can be configured according to any number of patterns since a touch panel can be customized to correspond to any particular button configuration.

Additionally, the remote controller can use various transmission methods to communicate to its corresponding electronic device, such as infrared rays (“IR”), Bluetooth, or any other suitable wireless or wired technologies for remote controllers. However, in practice, IR can be used to minimize production costs. The present invention will be described using an IR transmitter to transmit commands from the remote controller to a corresponding electronic device for remote control of the corresponding electronic device. However, it is understood that any transmission method can be used to transmit commands from the remote controller.

Furthermore, in addition to the various button configurations for a remote controller, the remote controller can also be partitioned into several areas corresponding to several remotely controlled devices. FIG. 7 illustrates a remote controller of the present invention having four areas on the touch panel, where each area corresponds to a different electronic device to be remotely controlled. A first area can be designated for controlling a television, a second area can be designated for controlling a stereo system, a third area can be designated for controlling a DVD player, and a fourth area can be designated for controlling an air conditioning unit.

In each of the designated areas, there can be specific buttons for controlling the corresponding electronic device. For instance, the first area can have virtual buttons corresponding to digits for selecting a channel to view on the television. The second area may have equalizer controls for the stereo system. The third area may have a play, stop, rewind, and fast forward virtual buttons for operating the corresponding DVD player. Even more so, the touch panel of the remote controller can be further divided as many times as desired for simultaneously operating any number of electronic devices.

The designated areas can also be used in a mouse mode by analyzing sliding behavior on the touch panel surface for web navigation or for navigation of other interfaces.

The touch panel of the remote can be implemented using touch sensing technologies, such as a resistance touch panel made from indium tin oxide (“ITO”) materials having single-touch capability, a capacitance touch panel made from ITO materials having multi-touch capability, a capacitance touch panel pattern laid on a printed circuit board (“PCB”) having single-touch capability, or other touch sensing technologies. In practice, in order to produce an inexpensive remote, it may be preferable to use a capacitance touch panel pattern laid on a PCB as described in the system below. However, it is understood that other touch sensing technologies may also be used in the present invention.

Furthermore, in an embodiment of the present invention where an ITO is used to implement the touch panel, the ITO can be driven in a resistive mode or in a capacitive mode, depending on the type of the ITO technology used. A LCD screen can be positioned under the ITO to form a touch screen remote with a flexible button configuration such that the touch screen can have the capability to provide and display various button configurations.

Referring back to FIG. 3a, FIG. 3a illustrates a capacitance touch panel pattern laid on a PCB. As stated above, the touch panel can have channels arranged in a grid pattern to detect the location of an object near or touching the touch panel.

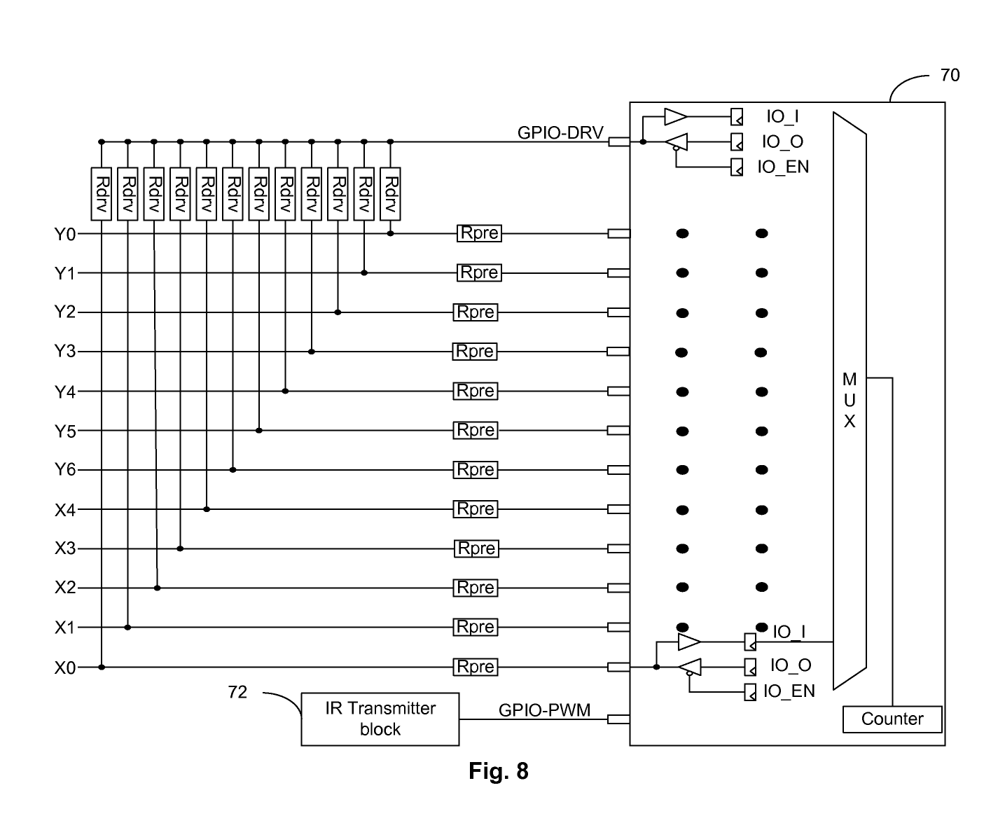

With respect to implementation of the capacitance touch panel illustrated in FIG. 3a, FIG. 8 illustrates a block diagram for implementing the capacitance touch panel pattern laid on a PCB. A controller 70 can have a general purpose input/output (“GPIO”) pin connected to each of the twelve capacitance touch sensing channels Y0-Y6 and X0-X4, thus having a total of twelve GPIO pins for reading the X-channels and Y-channels.

For each of the channels Y0-Y6 and X0-X4, the channel is connected to a first terminal of a serial-in resistor, Rpre, which is preferably 10K ohms, to provide current limitation. A second terminal of the Rpre resistor is connected to the corresponding GPIO pin for the channel.

The controller 70 can also have a GPIO pin (“GPIO_DRV”) for common drive purposes. This common drive connects to the twelve capacitance sensing channels Y0-Y6 and X0-X4 through twelve serial-in resistors, Rdrv, which are preferably 10M ohms each, for further current limitation of a small amount.

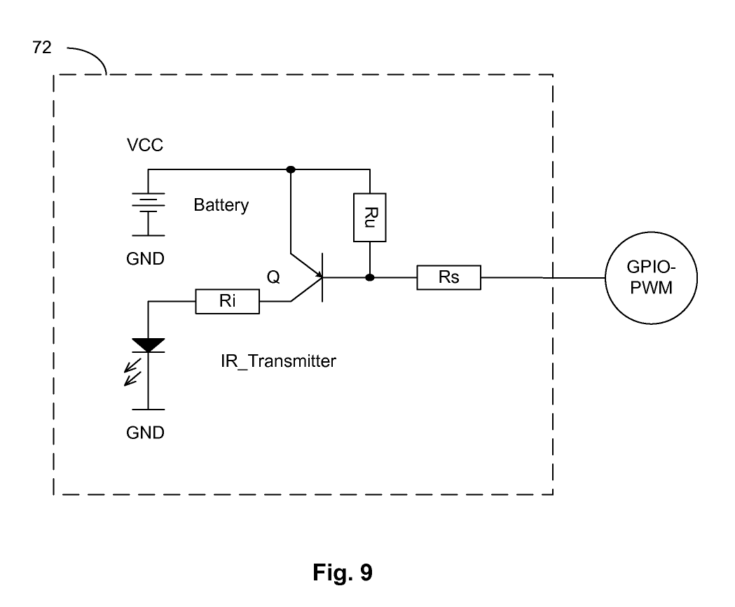

The controller 70 can have another GPIO pin (“GPIO-PWM”) for driving an IR transmitter block 72. FIG. 9 illustrates a typical IR transmitter block. The controller's GPIO-PWM pin drives the IR transmitter block 72. The GPIO-PWM pin is connected to a resistor Rs, where the resistor Rs is further connected to the base (e.g., a SS8550 is a BJT) of a transistor. The emitter of the transistor is connected to a voltage V_{CC}, and the collector of the transistor is connected to an IR transmitting diode via a resistor Ri. Preferably, the IR transmitter block 72 can be an IR204A, where Q is SS8550, Ru=10K ohms, Rs=1K ohms, and Ri=18 R ohms.

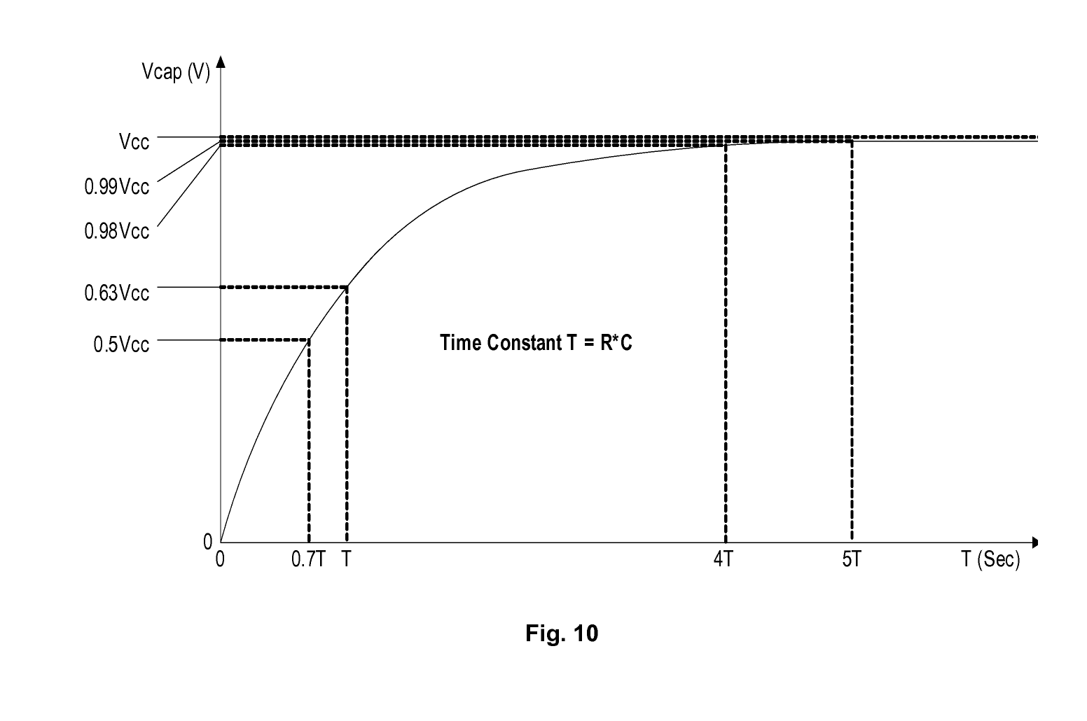

FIG. 10 illustrates a basic theory of capacitance measurements for GPIO pins. The RC charging curve can be given by

V_{CAP}(t)=V_{CC}*(1−e^{-t/(R*C)}). (1)

The time constant, τ, can be defined as follows:

τ=R*C=1. (2)

After a time of 0.7τ, the V_{CAP} voltage will exceed 0.5V_{CC}; after a time τ, the V_{CAP} voltage will exceed 0.63V_{CC}; after a time 4τ, the V_{CAP} voltage will exceed 0.98V_{CC}, a so-called “Transient Period”; after a time 5τ, the V_{CAP} voltage will exceed 0.99V_{CC}, a so-called “Steady State Period”, which can be considered as fully charged.

The RC discharging curve (not shown) can be given by

V_{CAP}(t)=V_{CC}*e^{-t/(R*C)}. (3)

The RC charging curve and the RC discharging curve are mirrored to each other. Therefore, they have the similar features mentioned above for the times, 0.7τ, τ, 4τand 5τ.

For a GPIO input pin, when the voltage on the pin is above a logic HIGH threshold (“V_{HIGH}”), the GPIO input for that pin can be set to a logic HIGH. When the voltage on the pin is below a logic LOW threshold (“V_{LOW}”), the GPIO input for that pin can be set to a logic LOW. Thus, if the V_{CAP} voltage of the RC charging/discharging circuit is connected to a GPIO pin, then the GPIO input can reflect the logic HIGH when the V_{CAP} voltage goes beyond the V_{HIGH} threshold voltage and can reflect the logic LOW when the V_{CAP} voltage goes below the V_{LOW} threshold voltage.

During the RC charging, the voltages V_{CC} and V_{HIGH} and the resistance R are known, thus giving a time t for the corresponding GPIO input to reach the logic HIGH. Therefore, Equation (1) can be rewritten as,

C=A*t, where A=−1/(R*ln((VCC−V_{HIGH}/VCC)). (4)

During RC discharging, the voltages V_{CC} and V_{LOW} and the resistance R are also known, thus giving a time t for the corresponding GPIO input to reach the logic HIGH. Therefore, Equation (2) can be rewritten:

C=B*t, where B=−1/(R*ln(V_{LOW}/VCC)). (5)

When the voltage V_{LOW}=V_{CC}−V_{HIGH}, then A=B.

In practice, a touch pad laid on a PCB can have an effective capacitance, Cx. When an object (e.g., a finger) touches or is in close proximity to the touch pad, then a capacitance Cf, corresponding to the object can be added to the total capacitance of the touch pad (i.e., Cx+Cf).

In order to simplify the equations the following variables can be defined as follows.

For the case where an object is not touching and not in close proximity to the touch pad, a time t_{H} can be defined as the amount of time for the GPIO input to reach the logic HIGH during RC charging and a time t_{L} can be defined as the amount time for the GPIO input to reach the logic LOW during RC discharging.

For the case where an object is touching or in close proximity to the touch pad, a time t_{H}′ can be defined as the amount of time for the GPIO input to reach the logic HIGH during RC charging and t_{L}′ can be defined as the amount of time for the GPIO input to reach logic LOW during RC discharging.

Thus, the capacitance during charging of Cx is

Cx=A*t_{H}, where A=−1/(R*ln((V_{CC}−V_{HIGH}/V_{CC})). (6)

The capacitance during discharging is

Cx=B*t_{L}, where B=−1/(R*ln(V_{LOW}/V_{CC})). (7)

Likewise when an object is touching the touchpad, then the corresponding equation for the total capacitance is given by

Cx+Cf=A*t_{H}′, where A=−1/(R*ln((V_{CC}−V_{HIGH}/V_{CC})) and (8)

Cx+Cf=B*t_{L}′, where B=−1/(R*ln(V_{LOW}/V_{CC})). (9)

Using Equations (6) and (8), the capacitance Cf can be given by

Cf=A*(t_{H}′−t_{H}), where A=−1/(R*ln((V_{CC}−V_{HIGH}/V_{CC})). (10)

Furthermore, using Equations (7) and (9), the capacitance Cf can also be given by

Cf=B*(t_{H}′−t_{H}), where B=−1/(R*ln(V_{LOW}N_{CC})). (11)

Also, Equations (6)-(9), can be used to solve for the times t_{H}, t_{L}, t_{H}′, and t_{L}′ giving

t_{H}=Cx/A, where A=−1/(R*ln((V_{CC}−V_{HIGH}/V_{CC})), (12)

t_{L}=Cx/B, where B=−1/(R*ln(V_{LOW}N_{CC})), (13)

t_{H}′=(Cx+Cf)/A, where A=−1/(R*ln((V_{CC}−V_{HIGH}/V_{CC})), and (14)

t_{L}′=(Cx+Cf)/B, where B=−1/(R*ln(V_{LOW}N_{CC})). (15)

According to Equations (12) through (15), when the voltage V_{LOW}=V_{CC}-V_{HIGH}, then t_{H}=t_{L} and t_{H}′=t_{L}′. Thus, we can use either RC charging, RC discharging, or even both to determine Cf for touch detection on the touch pad.

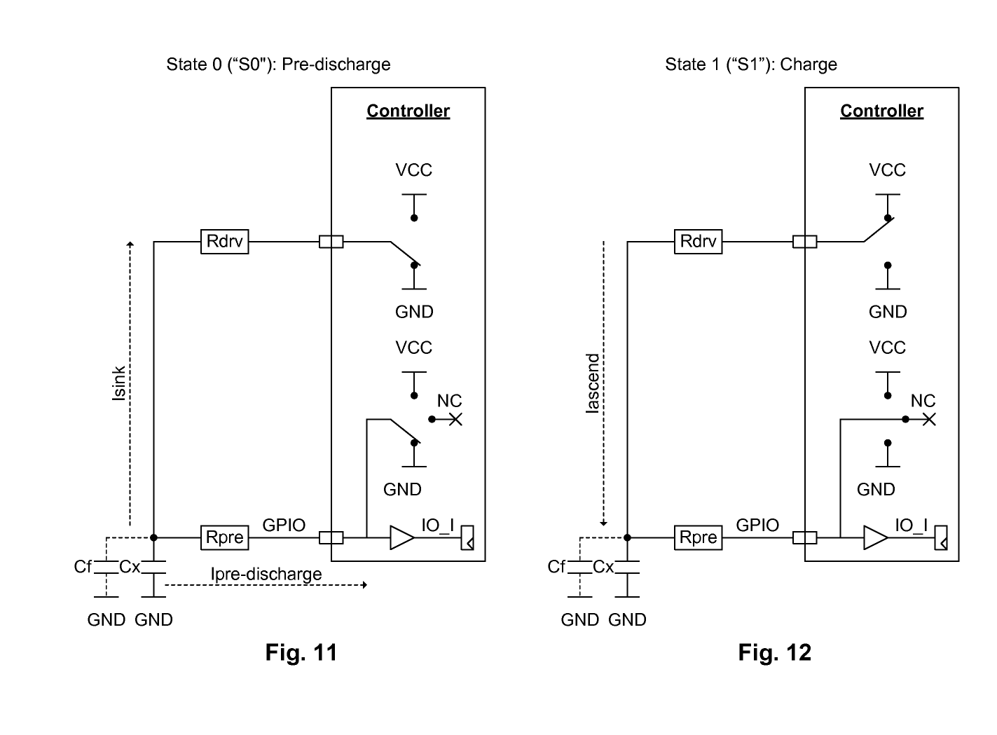

In the working mode of sensing a touch event, FIGS. 11-14 illustrate the basic states for capacitance measurements for the GPIO pins connected to the X-channels and Y-channels of the touch panel.

In particular, FIG. 11 illustrates a controller connected to a channel of the touch panel during a pre-discharging state. A pre-discharging stated can be referred to as state S0. During the pre-discharging state, the controller connects the channel to ground via the resistors Rdrv and Rpre to discharge the channel.

The pre-discharging state can then be followed by a charging state, which can be referred to as state S1. FIG. 12 illustrates the controller connected to the channel of the touch panel during the charging state. In the charging state, the resistor Rdrv has a terminal connected to the voltage potential V_{CC} and another terminal connected to the channel. The controller can read the voltage potential at the channel via the resistor Rpre.

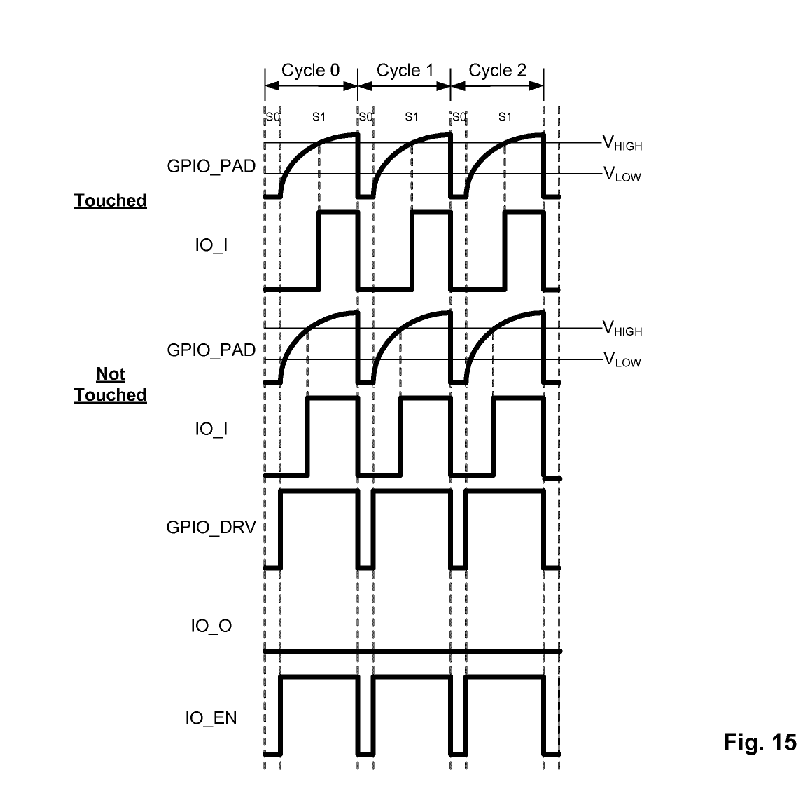

The states S0 and S1 are for a rising-edge-mode measurement. FIG. 15 illustrates the associated waveform for this mode.

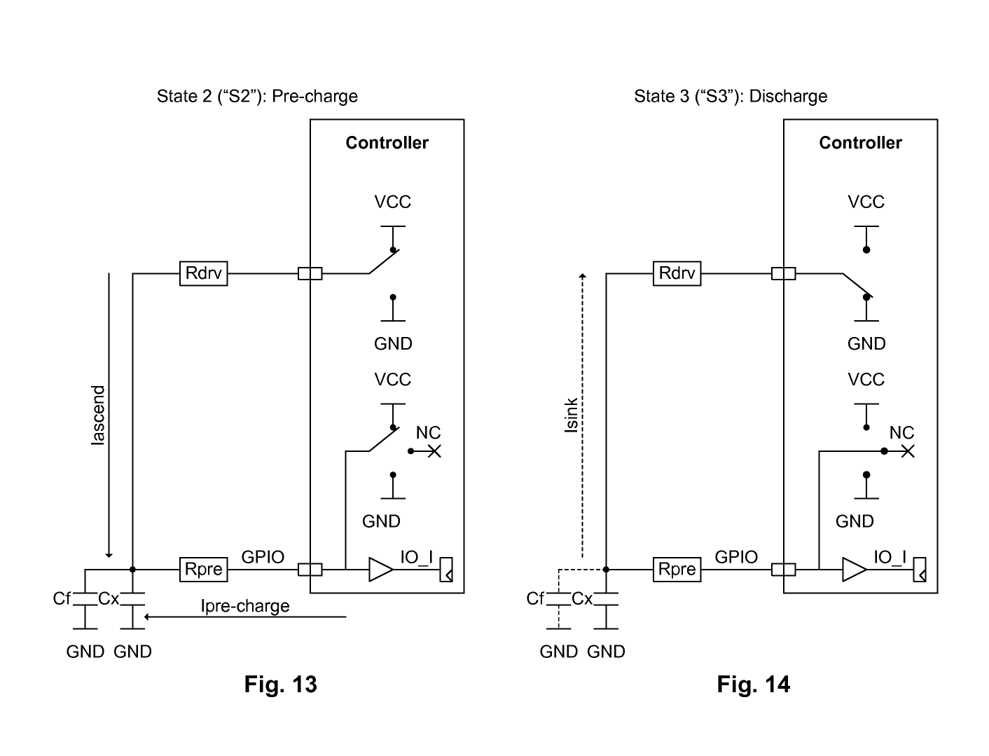

FIG. 13 illustrates the controller connected to the channel of the touch panel during a pre-charging state. A pre-charging state can be referred to as state S2. During the pre-charging state, the controller connects the channel to the voltage potential V_{CC} via the resistors Rdrv and Rpre to charge the channel.

The pre-charging state can be followed by a discharging state, which can be referred to as state S3. FIG. 14 illustrates the controller connected to the channel of the touch panel during the discharging state. During the discharging state, the resistor Rdrv has a terminal connected to ground and another terminal connected to the channel. The controller can read the voltage potential at the channel via the resistor Rpre.

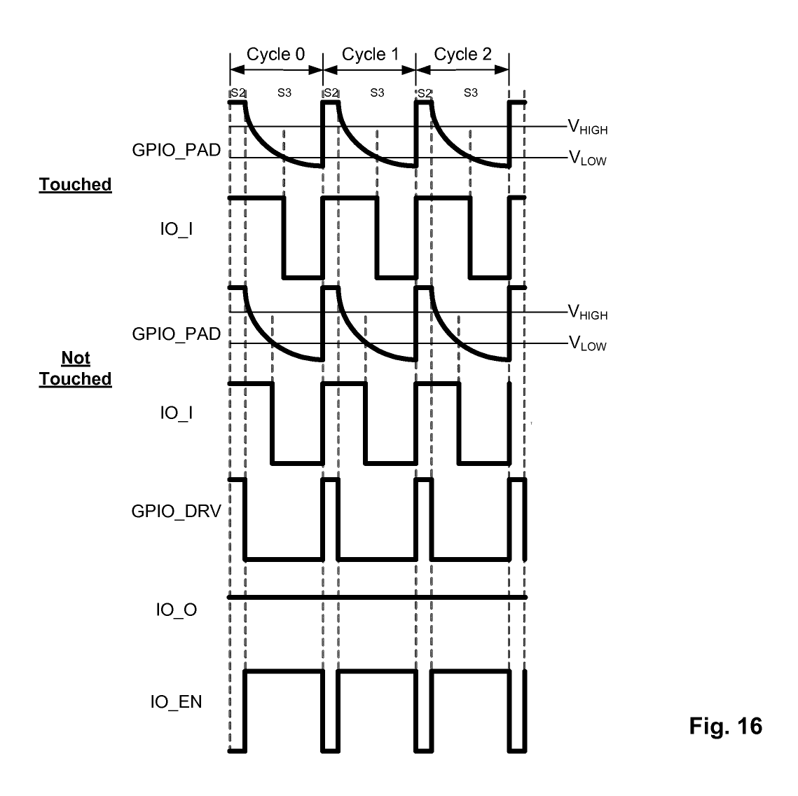

The states S2 and S3 are for falling-edge-mode measurement. FIG. 16 illustrates the associated waveform for this mode.

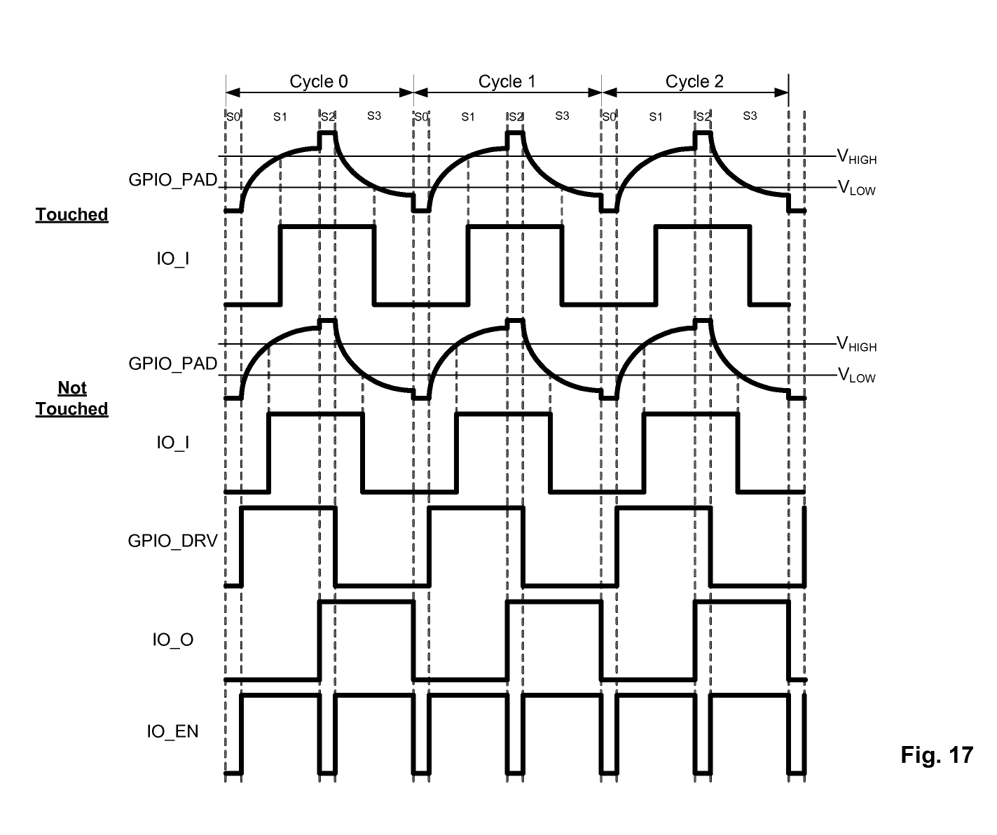

If state S0 is followed by state S1 and if state S2 is followed by state S3, then both-edge-mode measurements can be made. FIG. 17 illustrates the waveform for this mode.

Given V_{CC}=3.3V, V_{HIGH}=2.2V, V_{LOW}=1.1V, then V_{LOW}=V_{CC}-V_{HIGH} and, in theory, A=B, t_{H}=t_{L}, and t_{H}′=t_{L}′. Also, given that Rdrv=10M ohms, Rpre=10K ohms, Cx<20 pF, and Cf<1 pF, then the following results can be found.

For states S0 and S2, the following can be found that R=Rpre∥Rdrv and C<=Cx+Cf<20 pF+1 pF=21 pF. The time constant τ=R*C<210 nS, according to Equation (1). Thus, while in a Steady State Period, 5τ<1.05 uS.

For states S1 and S3, the following can also be found that R=Rdrv and C<=Cx+Cf<20 pF+1 pF=21 pF. Thus, A=B=−1/(R*ln(V_{LOW}/V_{CC}))=9.1*10−8. Therefore, according to Equations (15) and (16), t_{H}′=C/A=t_{L}′=C/B<=(Cx+Cf)/B<(20 pF+1 pF)/(9.1*10−8)=231 uS.

In order for the controller to operate optimally and get significant readings for touch detection, state S0=S2>1.05 uS and state S1=S3>231 uS.

It is important to note that the states S0, S1, S2, and S3 may vary depending on the various voltages V_{CC}, V_{HIGH}, and V_{LOW}, the various resistances Rdrv and Rpre, and the various capacitances Cx and Cf, as evidenced in the equations listed above. Furthermore, for all measurement modes, the sample cycle is trigged periodically, e.g., every 10 mS. Each sample cycle has an active phase and an idle phase, wherein each active phase may have sub-cycles. Each sub-cycle is combined with states S0 and S1 in the rising-edge-mode, or states S2 and S3 in the falling-edge-mode, or states S0, S1, S2, and S3 in both-edge-mode.

If states S0=S2=2 uS and S1=S3=248 uS, then states S0 and S1=250 uS, states S2 and S3=250 uS, and states S0, S1, S2, and S3=500 uS. Furthermore, if we use sixteen sub-cycles of states S0 and S1 for an active phase in the rising-edge-mode, for example, though it can be flexible, the active phase will last for about 16*250 uS=4 mS, while the idle phase will last for about 10 mS−4 mS=6 mS. If we use sixteen sub-cycles of states S2 and S3 for active phase in falling-edge-mode, for example, though it can be flexible, the active phase will last for about 16*250 uS=4 mS, while the idle phase will last for about 10 mS−4 mS=6 mS.

If eight sub-cycles of states S0, S1, S2, and S3 for an active phase in both-edge-mode, for example, though it can be flexible, the active phase will last for about 8*500 uS=4 mS, while the idle phase will last for about 10 mS−4 mS=6 mS. For each sample cycle, a different averaging method can be used to work out the final result of the sixteen original readings for t_{H}′ or t_{L}′, or eight pairs of t_{H}′ and t_{L}′. For example, an average of the middle eight out of sixteen original readings can be used to work out the final result t_{H}′ or t_{L}′, for the falling-edge-mode or the rising-edge-mode. The average of those middle four out of eight pairs of the original readings can be used to work out one pair of final results t_{H}′ and t_{L}′ separately, for the both-edge-mode. It is understandable that the averaging methods can also be flexible.

Notice that the times t_{H} and t_{L} can be calibrated without an object having to touch the touch pad. In fact, the capacitance of the object can be found by,

Cf=A*(t_{H}′−t_{H}) or Cf=B*(t_{L}−t_{L}). (16)

Now after the Cf has been detected on all the channels, an algorithm can be used to determine the location of an object on the touch panel (if any). In order to determine a location of an object, the capacitance Cf for each of the channels can be denoted C_{X0} to C_{X4} and C_{Y0} to C_{Y6}, which corresponds to the channels X0-X4 and Y0-Y6, respectively.

To calculate the touching or sliding point position, the common capacitance Cf across the channels can be eliminated as common noise. In order to find the common capacitance Cf, the minimum capacitance value for C_{X0} to C_{X4} is determined and can be denoted Xₘᵢₙ; the minimum capacitance value for C_{Y0} to C_{Y6} is determined and can be denoted Yₘᵢₙ; the maximum capacitance value for C_{X0} to C_{X4} is determined and can be denoted Xₘₐₓ; the maximum capacitance value for C_{Y0} to C_{Y6} is determined and can be denoted Y.

Next, the capacitance for each channel is subtracted by the corresponding minimum value for the set of those channels as follows

V_{Xm}=C_{Xm}−Xₘᵢₙ, where m=0˜4, and (17)

V_{Yn}=C_{Yn}−Yₘᵢₙ, where n=0˜6. (18)

If a touch panel is mapped to an active area having the resolution of 80×120, with a pitch resolution equal to 20, i.e., pitch=20, then the X and Y channels can be mapped to a coordinate system and have a position (e.g., a distance) associated with each of the channels along the coordinate system.

For instance, with respect to the X-channels, the channel X0 can be the origin in relation to the other X-channels and can have a position denoted D_{X0} along the x-axis, where D_{X0}=0. The channel X1 can have a position denoted D_{X1} along the x-axis, where D_{X1}=D_{X0}+pitch=20. The channel X2 can have a position denoted D_{X2} along the x-axis, where D₂=D_{X1}+pitch=40. The channel X3 can have a position denoted D_{X3} along the x-axis, where D_{X3}=D_{X2}+pitch=60. The channel X4 can have a position denoted D_{X4} along the x-axis, where D_{X4}=D_{X3}+pitch=80. If additional X-channels are available, then the other X-channels can be assigned a position along the x-axis in increments of the pitch.

With respect to the Y-channels, the channel Y0 can be the origin in relation to the other Y-channels and can have a position denoted D_{Y0} along the y-axis, where D_{Y0}=0. The channel Y1 can have a position denoted D_{Y1} along the y-axis, where D_{Y1}=D_{Y0}+pitch=20. The channel Y2 can have a position denoted D_{Y2} along the y-axis, where D_{Y2}=D_{Y1}+pitch=40. The channel Y3 can have a position denoted D_{Y3} along the y-axis, where D_{Y3}=D_{Y2}+pitch=60. The channel Y4 can have a position denoted D_{Y4}, where D_{Y4}=D_{Y3}+pitch=80. The channel Y5 can have a position denoted D_{Y5}, where D_{Y5}=D_{Y4}+pitch=100. The channel Y6 can have a position denoted D_{Y6} where D_{Y6}=D_{Y5}+pitch=120. If other Y-channels are available, the other Y-channels can be assigned a position along the y-axis in increments of the pitch.

The touching or sliding point position (X,Y) can be located according to the coordinate system, using the following equations:

X=(V_{X0}²*D_{X0}+V_{X1}²*D_{X1}+V_{X2}²*D_{X2}+V_{X3}²*D_{X3}+V_{X4}²*D_{X4})/S_{X}. (19)

Y=(V_{Y0}²*D_{Y0}+V_{Y1}²*D_{Y1}+V_{Y2}²*D_{Y2}+V_{Y3}²*D_{Y3}+V_{Y4}²*D_{Y4}+V_{Y5}²*D_{Y5}+V_{Y6}²*D_{Y6})/S_{Y}. (20)

where,

S_{X}=V_{X0}²+V_{X1}²+V_{X2}²+V_{X3}²+V_{X4}² and (21)

S_{Y}=V_{Y0}²+V_{Y1}²+V_{Y2}²+V_{Y3}²+V_{Y4}²+V_{Y5}²+V_{Y6}². (22)

In order to ensure the readings are accurate, the X and Y values can be validated by using a threshold value, H_{THR}X and H_{THR}Y, accordingly. Therefore, the X value is valid if and only if Xₘₐₓ−Xₘᵢₙ>H_{THR}X or S_{X}>2*H_{THR}X². And, the Y value is valid if and only if Yₘₐₓ−Yₘᵢₙ>H_{THR}Y or S_{Y}>2*H_{THR}Y².

A remote controller can be coupled to a user interface of the remotely controlled device. In addition to the various inputs for remotely controlling a device as previously discussed, other specific inputs can be implemented for a unique experience. With respect to graphical user interfaces (e.g., computer operating systems), the user may employ various input methods, such as sliding an object along the touch panel of the remote controller to generate an analogous action on the screen displaying the graphical user interfaces. For instance, the touch panel of the remote controller can serve as a remote computer mouse.

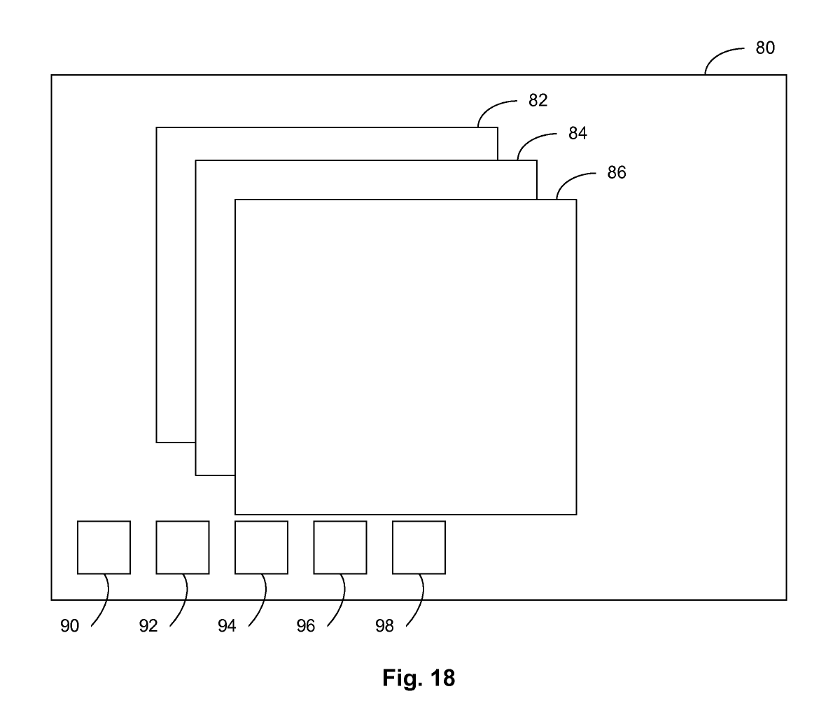

FIG. 18 illustrates a graphical user interface that can be remotely controlled by a remote controller of the present invention. A user can input a command to alternate the display of windows 82, 84, and 86 within the graphical user interface 80 to the front of the display for viewing by sliding an object along the remote controller in a predefined path to select which window to display prominently. Alternatively, the user can press a virtual button on the remote controller to open an application or graphical interface. The various applications or graphical interfaces can be displayed on icons 90, 92, 94, 96, and 98 of the graphical user interface 80 to indicate which applications or graphical interfaces are available.

In yet another embodiment, a touch of the top surface of the remote controller can pop out a virtual graphical user interface (or an interface) on the screen of a display device. The virtual graphical user interface can correspond to the top surface of the remote controller, allowing the user to select a desired function by simply pressing the area on the top surface of the remote controller as indicated by the virtual GUI. The virtual GUI can be tailored to the different functions to be provided or to the different levels of menu functions. For example, one tap to the top surface of the remote controller would bring up a virtual GUI on the screen; and the virtual GUI would divide up the top surface of the remote controller into four (4) selectable functions areas, TV control, DVD control, Audio control, and Games. By tapping one of the four function areas on the top surface of the remote controller, that function is selected (e.g. TV control) and the respective sub-functions for selected function would be displayed on the virtual GUI (and again corresponds to the top surface of the remote controller) providing for the sub-functions (e.g. TV color, TV audio, TV source, etc.).

The virtual GUI can be designed in a number of ways and customizable to the desired preferences. For example, the virtual GUI can be designed by the user of the remote controller, where there may be several pages of functions and each page of functions correspond to the top surface of the remote controller. The user can scroll through the functions a number of ways, including the sliding method described above and the sub-menu/sub-function methods also described above.

In another embodiment, the touch panel of the remote controller can be designed as a virtual keyboard such that the virtual keys can be mapped to the touch panel. The orientation of the touch panel can be detected to adjust the mapping of the virtual keys to the touch panel.

The touch panel of the remote controller can also be mapped to the display of the graphical user interface such that it can perform similarly to a computer mouse. The user can use an object to guide along the touch panel of the remote controller and have a corresponding movable pointer (e.g., an arrow or other icon) displayed on a screen to move in a synchronized fashion with the user's object.

Likewise if the remote controller supports a multi-touch panel, then more various sliding input commands can be implemented. The remote controller can also interact with the display, such that upon activating said touch panel, one or more interfaces can be provided on the display.

Generally, the remote controller can have a button or a designated area on the touch panel to activate a corresponding electronic device, where the user can touch or place an object in close proximity to that area to activate the corresponding electronic device. The user may also be able to shake the remote controller to command the remote controller to activate the electronic device, instead of having to touch any pre-designated virtual buttons. Shaking the remote controller can also be used to turn on the remote controller or wake up the remote controller from a sleep mode. In an embodiment of the present invention, an additional sensor can be used for shaking detection.

Furthermore, a hardware module that supports a sleep mode can auto detect a touch event on the panel at any position and can generate an interrupt to wake up the CPU to check for further inputs from a user.

Also, the remote control device can have an on-state and an off-state, where a mechanism (e.g., accelerometer, a plurality of magnetic coils, or other mechanism) is disposed in the remote control, where a stroke across the mechanism can switch the remote control device from the off-state to the on-state. Furthermore, during the off-state, the remote control may substantially reduce or eliminate all power consumption.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A remote controller device, comprising:
a unit having a top surface; and
a touch panel disposed on said top surface,
wherein said touch panel covers all of said top surface.

2. The remote controller device of claim 1 wherein said top surface has no physical buttons.

3. The remote controller device of claim 1 wherein said touch panel is flat.

4. The remote controller device of claim 1 wherein said remote controller device interacts with a display device, and upon activating said touch panel, one or more interfaces are provided on the display device.

5. The remote controller device of claim 4 wherein said interfaces include a movable pointer.

6. The remote controller device of claim 4 wherein upon sliding on said touch panel at a designated portion of said touch panel, the interfaces are scrolled and a selected one of the interfaces is displayed on the display device.

7. The remote controller device of claim 4 wherein a selected one of the interfaces is displayed on the display device and the selected interface provides for selectable functions for two or more devices corresponding to two or more designated areas on the touch panel.

8. The remote controller device of claim 4 wherein the interfaces are user customizable.

9. The remote controller device of claim 4 wherein each of said interfaces comprises a plurality of virtual buttons.

10. The remote controller device of claim 1 wherein the touch panel comprises capacitance touch sensing channels, wherein said capacitance touch sensing channels form a grid pattern on the top surface.

11. The remote controller of claim 10 wherein each of the capacitance touch sensing channels comprises a plurality of touch pads, wherein the touch pads are positioned on a first surface of a PCB.

12. The remote controller of claim 10 wherein the capacitance touch sensing channels are mapped to a coordinate system.

13. The remote controller of claim 13 wherein a location of an object is determined based on capacitances measured for said capacitance touch sensing channels and the mapped positions of the capacitance touch sensing channels on the coordinate system.

14. The remote controller device of claim 1 wherein said remote controller device having an on-state and an off-state, wherein a plurality of magnetic coils is disposed on said touch panel, wherein a stroke across said plurality of magnetic coils toggles said remote controller device between the off-state and the on-state, and wherein during the off-state said remote controller device does not consume power.

15. The remote controller device of claim 1 wherein said remote controller device having an on-state and an off-state, wherein a shaking detection device is disposed within said remote controller device, wherein upon shaking said remote controller device, said remote controller device toggles between the off-state and the on-state, and wherein during the off-state said remote controller device does not consume power.

16. A remote controller device, comprising:
a unit having a top surface; and
a touch panel disposed on said top surface,
wherein said touch panel is flat and covers all of said top surface, wherein said top surface has no physical buttons, wherein the touch panel comprises capacitance touch sensing channels, wherein said capacitance touch sensing channels form a grid pattern on the top surface, wherein each of the capacitance touch sensing channels comprises a plurality of touch pads, and wherein the touch pads are positioned on a first surface of a PCB.

17. The remote controller device of claim 16 wherein said remote controller device interacts with a display device, and upon activating said touch panel, one or more interfaces are provided on the display device, wherein said interfaces include a movable pointer, wherein upon sliding on said touch panel at a designated portion of said touch panel, the interfaces are scrolled and a selected one of the interfaces is displayed on the display device, wherein the selected interface provides for selectable functions for two or more devices corresponding to two or more designated areas on the touch panel, wherein the interfaces are user customizable, and wherein each of said interfaces comprises a plurality of virtual buttons.

18. The remote controller of claim 16 wherein the capacitance touch sensing channels are mapped to a coordinate system, and wherein a location of an object is determined based on capacitances measured for said capacitance touch sensing channels and the mapped positions of the capacitance touch sensing channels on the coordinate system.

19. The remote controller device of claim 16 wherein said remote controller device having an on-state and an off-state, wherein a hardware module is disposed in said remote controller device, wherein a detected event by the hardware module toggles said remote controller device between the off-state and the on-state.

20. A remote controller device, comprising:
a unit having a top surface; and
a touch panel disposed on said top surface,
wherein said touch panel is flat and covers all of said top surface, wherein said top surface has no physical buttons, wherein said remote controller device interacts with a display device, and upon activating said touch panel, one or more interfaces are provided on the display device, wherein said interfaces include a movable pointer, wherein upon sliding on said touch panel at a designated portion of said touch panel, the interfaces are scrolled and a selected one of the interfaces is displayed on the display device, wherein the selected interface provides for selectable functions for two or more devices corresponding to two or more designated areas on the touch panel, wherein the interfaces are user customizable and comprises a plurality of virtual buttons, wherein the touch panel comprises capacitance touch sensing channels, wherein said capacitance touch sensing channels form a grid pattern on the top surface, wherein each of the capacitance touch sensing channels comprises a plurality of touch pads, wherein the touch pads are positioned on a first surface of a PCB, wherein the capacitance touch sensing channels are mapped to a coordinate system, wherein a location of an object is determined based on capacitances measured for said capacitance touch sensing channels and the mapped positions of the capacitance touch sensing channels on the coordinate system, and wherein the remote controller having an on-state and an off-state.
